(19) United States
(12) Patent Application Publication
(10) Pub. No.: US 2016/0152160 A1
(43) Pub. Date: Jun. 2, 2016

(54) CONTROL METHOD FOR VEHICLE

(71) Applicants: TOYOTA BOSHOKU KABUSHIKI KAISHA, Aichi-ken (JP); DENSO CORPORATION, Aichi-ken (JP)

(72) Inventors: Masaru SAKATA, Toyota-shi (JP); Keisuke TODA, Kariya-shi (JP); Takeshi ENYA, Nagoya-shi (JP); Minori YAMATAKA, Nisshin-shi (JP)

(73) Assignees: TOYOTA BOSHOKU KABUSHIKI KAISHA, Aichi-ken (JP); DENSO CORPORATION, Aichi-ken (JP)

(21) Appl. No.: 14/721,299

(22) Filed: May 26, 2015

(30) Foreign Application Priority Data
Nov. 14, 2014 (JP) 2014-231622

(51) Int. Cl. B60N 2/02; B60K 35/00

(52) U.S. Cl. CPC B60N 2/0224; B60K 35/00

(57) ABSTRACT

A control method for a vehicle includes: predicting a position of an eye point of an occupant after a state of a vehicle seat is changed, based on amount of adjustment of an adjusting mechanism due to change in state of the vehicle seat; determining whether or not a display light reflected on a wind shield is passing through a predicted position of the eye point; and if it is determined that the display light reflected on the wind shield is not passing through the predicted position of the eye point, automatically operating a head-up display system or the adjusting mechanism so as to move one of a traveling path of the display light reflected on the wind shield and the eye point of the occupant toward the other.

### INCORPORATION BY REFERENCE

The disclosure of Japanese Patent Application No. 2014-231622 filed on May 27, 2014 including the specification, drawings and abstract is incorporated herein by reference in its entirety.

### BACKGROUND OF THE INVENTION

1. Field of the Invention

The present invention relates to a control method for a vehicle including a head-up display system and a vehicle seat.

2. Description of Related Art

As a vehicle of this type, Japanese Utility Model Application Publication No. 63-133417 discloses a vehicle including a head-up display system, vehicle seats, a wind shield, and a steering member. In such a vehicle, the head-up display system includes a luminous display unit, and a reflecting mirror that reflects a display light of the luminous display unit toward a wind shield, and this system is connected to the steering member through a coupling member. The coupling member is a link mechanism that moves the head-up display system frontward and backward in accordance with upward and downward movement of the steering member. In a conventional technique, if a small-sized occupant is seated in a vehicle seat, for example, while manually moving the steering member downward, the occupant moves the head-up display system forward in the vehicle through the coupling member. A reflecting position of the display light of the head-up display system is moved downward of the wind shield in this manner, thereby positioning an eye point of the occupant at a traveling path of the display light reflected on the wind shield.

### SUMMARY OF THE INVENTION

In a vehicle seat of this type, an adjusting mechanism, such as a sliding mechanism, a lifter mechanism, and a recliner mechanism, is so operated as to change a posture of the seat, or a position of the seat in a vehicle compartment in accordance with an occupant in some cases. For example, the recliner mechanism is so operated as to adjust a reclining degree of a seat back relative to a seat cushion, thereby changing the posture of the seat. At least one of the sliding mechanism and the lifter mechanism is so operated as to change the position of the seat in the forward and backward and the upward and downward directions in the vehicle. In a seat structure of this type, the position of the eye point (eyes) of the occupant is changed when a state of the vehicle seat is changed. Hence, every time the state of the vehicle seat is changed, it is required to appropriately adjust the reflection point of the display light relative to a wind shield such that the eye point of the occupant is positioned at a traveling path of the display light reflected on the wind shield.

Unfortunately, the above conventional technique employs a configuration to change the reflection position of the display light, and thus it is required to manually operate the steering member every time the state of the vehicle seat is changed. Hence, according to the configuration of this conventional technique, if the occupant neglects operation of the steering member, the eye point of the occupant deviates from the traveling path of the display light reflected on the wind shield; thus there may be a risk that appropriate information cannot be obtained from the display light. The present invention provides a control method for a vehicle capable of automatically and more appropriately positioning the eye point of an occupant at a traveling path of a display light reflected on a wind shield.

In a control method for a vehicle according to one aspect of the present invention, the vehicle includes a head-up display system, a vehicle seat, and a wind shield that reflects a display light of the head-up display system toward the vehicle seat. The vehicle seat includes an adjusting mechanism that changes a state of the vehicle seat in accordance with an occupant in a sitting state by changing a posture of the vehicle seat, or a position of the vehicle seat in a compartment of the vehicle. The head-up display system adjusts a reflection position of the display light relative to the wind shield so as to move a traveling path of the display light reflected on the wind shield in an upward and downward direction. In the present invention, the adjusting mechanism is operated in a manner as to change the state of the vehicle seat in accordance with the occupant in the sitting state, and to position an eye point of the occupant at the traveling path of the display light reflected on the wind shield. In this configuration, it is desirable to automatically and more appropriately position the eye point of the occupant at the traveling path of the display light reflected on the wind shield.

To address this, the control method for the vehicle according to the present invention includes: predicting a position of the eye point of the occupant after the state of the vehicle seat is changed, based on amount of adjustment of the adjusting mechanism due to change in state of the vehicle seat; determining whether or not the display light reflected on the wind shield is passing through the predicted position of the eye point; and if it is determined that the display light reflected on the wind shield is not passing through the predicted position of the eye point, automatically operating the head-up display system or the adjusting mechanism so as to move one of the traveling path of the display light reflected on the wind shield and the eye point of the occupant toward the other. In the present invention, it is possible to more precisely predict the position of the eye point based on the amount of adjustment of the adjusting mechanism, and more appropriately determine whether or not the display light reflected on the wind shield is passing through the predicted position of the eye point (eye point after the state is changed). The head-up display system or the adjusting mechanism is automatically operated, thereby positioning the eye point of the occupant at the traveling path of the display light reflected on the wind shield.

According to the aspect of the present invention, it is possible to automatically and more appropriately position the eye point of the occupant at the traveling path of the display light reflected on the wind shield.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic side view of part of a vehicle compartment;

FIG. 2 is a schematic side view of a steering member;

FIG. 3 is a side view of part of a head-up display system; and

FIG. 4 is a flowchart showing a control procedure of a vehicle.

### DETAILED DESCRIPTION OF EMBODIMENTS

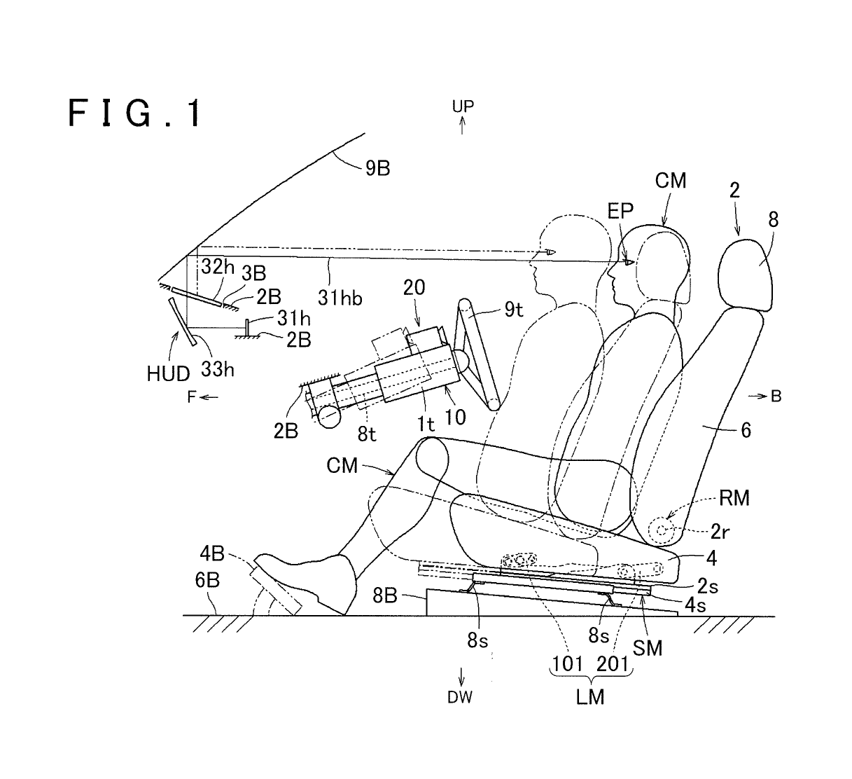

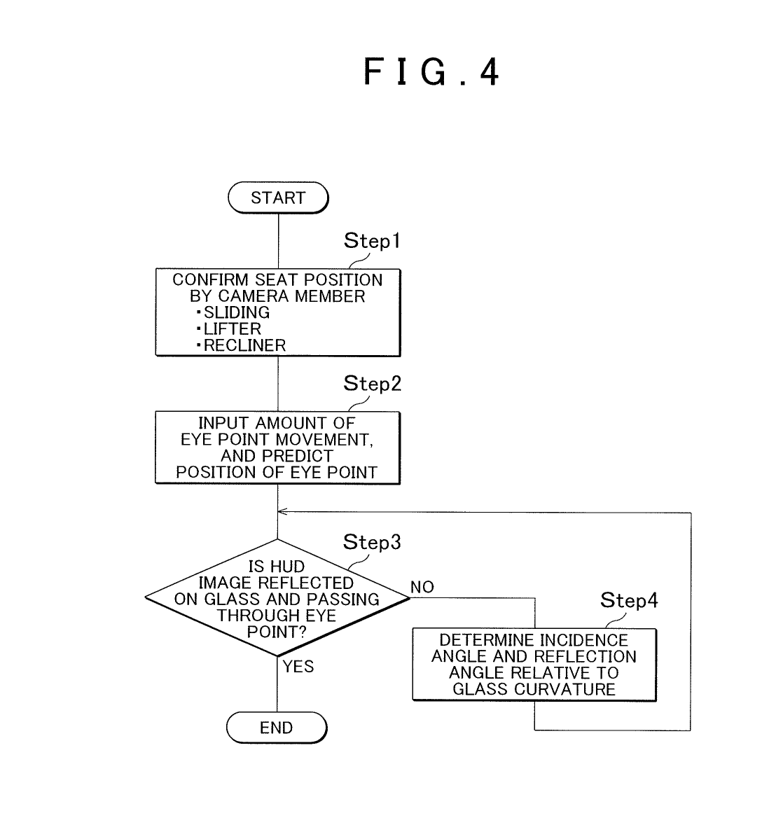

Embodiments according to the present invention will be described with reference to FIG. 1 to FIG. 4, hereinafter. In FIG. 1, only part of an instrument panel is shown for convenience of explanation. In FIG. 4, a wind shield is expressed as a “glass” for convenience of explanation. In each drawing, a reference character “F” denotes a frontward direction of a vehicle seat, a reference character “B” denotes a backward direction of the vehicle seat, a reference character “UP” denotes an upward direction of the vehicle seat, and a reference character “DW” denotes a downward direction of the vehicle seat, respectively. In a vehicle compartment of FIG. 1, there are provided, as basic components of the vehicle compartment, the instrument panel 2B, a pedal 4B, a floor surface 6B, the wind shield 9B, a head-up display system HUD, a vehicle seat 2, a steering member 10, and a camera member 20.

The instrument panel 2B is a wall body that is located at a front section of the vehicle compartment, and standingly extends from the floor surface 6B, and the instrument panel 2B is provided with the head-up display system HUD described later, the steering member 10, and the camera member 20. The pedal 4B is disposed at the front section of the floor surface 6B in the vehicle compartment, and is located below the instrument panel 2B. The wind shield 9B is a transparent plate member that is gradually curved backward as it extends upward from below in the vehicle, and is located above the instrument panel 2B. The wind shield 9B may reflect a display light 31hb of the head-up display system HUD toward the vehicle seat 2, as described later.

The vehicle seat 2 is placed on the floor surface 6B at a more backward position than the instrument panel 2B in the vehicle compartment in a manner as to be at a position opposite to the wind shield 9B, the steering member 10, and the camera member 20. With reference to FIG. 1, the vehicle seat 2 includes a seat cushion 4, a seat back 6, a head rest 8, and adjusting mechanisms (a sliding mechanism SM, a lifter mechanism LM, a recliner mechanism RM) described later. The seat back 6 is tiltably coupled to a rear part of the seat cushion 4, and the head rest 8 is placed at a top of the seat back 6 in a stand-up state.

In the present embodiment, by operating at least one of the mechanisms SM, LM, and RM described later, a state of the vehicle seat 2 is so changed as to be adjusted to an occupant CM in a sitting state. An eye point EP of the occupant CM is positioned at a traveling path of the display light 31hb reflected on the wind shield 9B, thereby providing a state that allows the occupant CM to obtain effective information from the display light 31hb. In such a configuration, it is desirable to automatically and more appropriately position the eye point EP of the occupant CM at the traveling path of the display light 31hb reflected on the wind shield 9B. To address this, in the present embodiment, the eye point EP of the occupant CM is automatically and more appropriately positioned at the traveling path of the display light 31hb reflected on the wind shield 9B through configurations (the first stage to the third stage) described later. Each configuration will be described, hereinafter.

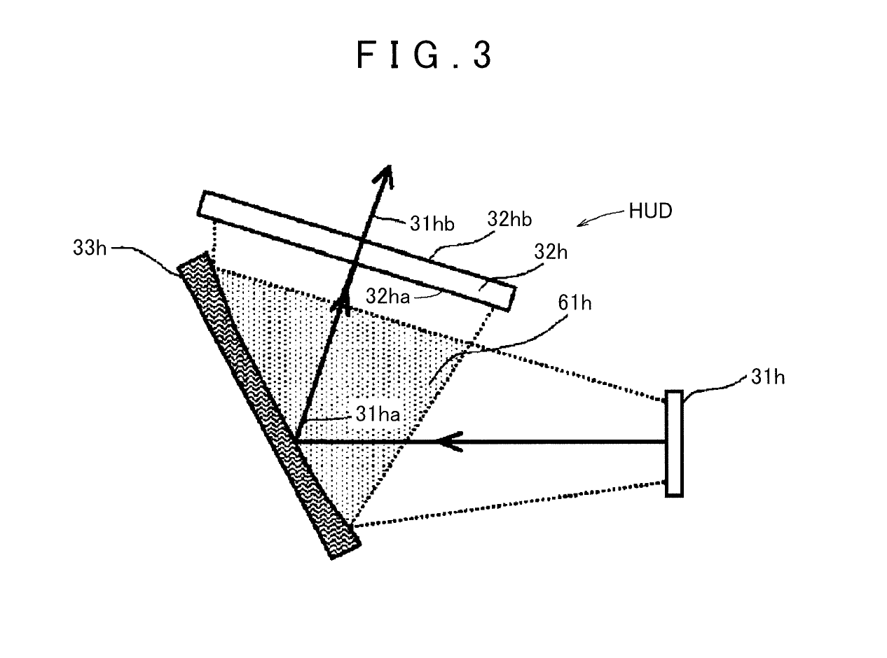

With reference to FIG. 1 and FIG. 3, the head-up display system HUD includes a mechanism that allows the occupant CM to visually recognize the display light 31hb (part of an enlarged image described later) reflected on the wind shield 9B as a virtual image. The head-up display system HUD includes a display device 31h that is an irradiating source, a Fresnel lens 32h that enlarges a display image of the display device 31h, and a free-curved surface mirror 33h. With reference to FIG. 1, these components included in an optical system are disposed inside the instrument panel 2B located below the wind shield 9B.

The Fresnel lens 32h is disposed in the vicinity of an aperture 3B of the instrument panel 2B in a manner as to be vertical to a ray axis of a reflected image 31ha described later (so-called “coaxial”). This Fresnel lens 32h is formed of a transparent plate member on which plural circular grooves are formed around the ray axis of the reflected image 31ha. The plural circular grooves are formed both on the free-curved surface mirror 33h side and on the wind shield 9B side of the Fresnel lens 32h. Between the display device 31h and the Fresnel lens 32h, the free-curved surface mirror 33h that defects the display image of the display device 31h is so disposed as to be inclined relative to the optical axis of the display image (so-called “off-axis”, inclined at 10° to 45°, for example). The optical axis denotes a light ray located at a centroid of a pencil of plural light rays constituting the display image and others.

The optical axis of the reflected image 31ha that is the display image reflected by the free-curved surface mirror 33h vertically enters an entry end surface 32ha of the Fresnel lens 32h. At this time, a double optical path space 61h is generated by intersection of a pencil of light rays of the display image radiated from the display device 31h and a pencil of light rays of a reflected image thereof, but respective traveling directions of these pencils of the light rays do not correspond to each other; thus these light rays do not interfere with each other. The optical axis of the reflected image 31ha vertically entering the entry end surface 32ha of the Fresnel lens 32h vertically exits from an exit end surface 32hb of the Fresnel lens 32h, thereby enlarging the reflected image 31ha of which source is the display image. The enlarged image obtained by enlarging the reflected image 31ha is projected on the wind shield 9B. Part of the light rays of the enlarged image projected on the wind shield 9B exemplifies the display light 31hb reflected on the wind shield 9B of the present invention, and is reflected by the wind shield 9B in the direction of the eye point EP of the occupant CM. This reflection allows the occupant CM to visually recognize a displayed virtual image.

The head-up display system HUD includes a movement mechanism configured to move a reflection position of the display light 31hb relative to the wind shield 9B in the upward and downward direction. A movement mechanism of this type may be exemplified by a mechanism that tilts one of the display device 31h and the free-curved surface mirror 33h toward the other (not shown in the drawings). The reflection position of the display light 31hb relative to the wind shield 9B is adjusted through the tilting movement of the display device 31h or the free-curved surface mirror 33h, thereby moving the traveling path of the display light 31hb reflected on the wind shield 9B in the upward and downward direction of the vehicle. This movement mechanism may be exemplified by such a movement mechanism that directly moves the head-up display system HUD in the forward and backward direction synchronously with upward and downward movement of the steering member 10 (described later) in the same manner as that in conventional techniques.

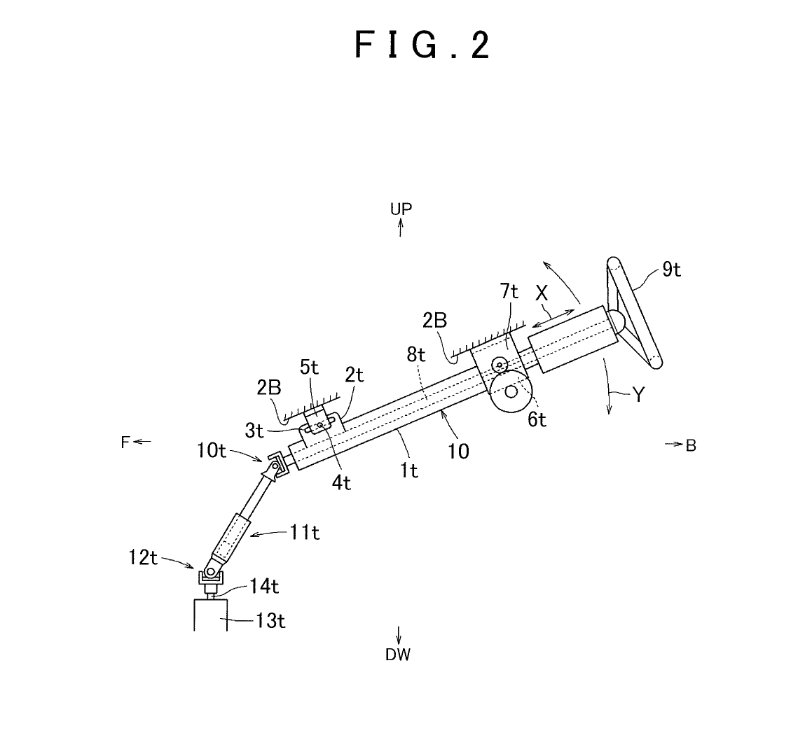

With reference to FIG. 1 and FIG. 2, the steering member 10 is so disposed as to be movable forward and backward, and upward and downward relative to the instrument panel 2B. The movable range of the steering member 10 is set within a relative range of the eye point EP of the occupant CM who has a common body size. The occupant CM of this type may be supposed to have a body size within a range from an occupant dummy equivalent to AM95 specified by the SAE standards to an occupant dummy equivalent to JF05 specified by the SAE standards.

With reference to FIG. 2, the steering member 10 includes a column 1t, a bar-shaped shaft 8t inserted in the column 1t, and a wheel 9t in a wheel shape disposed at an upper end of the shaft 8t. The column 1t is a cylindrical member whose upper portion has a slightly greater diameter so that the camera member 20 described later can be attached thereto (see FIG. 1). A lower bracket 2t is attached to the vicinity of a lower end of the column 1t. A long hole 3t is formed in the lower bracket 2t in a manner as to extend parallel to the column 1t, and the lower bracket 2t is coupled to a vehicle-side bracket 5t of the instrument panel 2B via a bolt shaft 4t residing in the long hole 3t. A movable bracket 6t is fixed to the vicinity of an upper end of the column 1t. The movable bracket 6t is engaged with a fixed bracket 7t of the instrument panel 2B in a manner as to be movable both in an arrow X direction and in an arrow Y direction as shown in FIG. 2. The wheel 9t is coupled to the upper end of the shaft 8t inserted in the column 1t, and an extendable universal shaft 11t is coupled to a lower end of the shaft 8t via a universal joint 10t. The extendable universal shaft 11t is also coupled to a shaft 14t of a gear box 13t through a universal joint 12t.

In the present embodiment, the movable bracket 6t is moved relative to the fixed bracket 7t in the arrow X direction in FIG. 2, thereby moving the steering member 10 (column 10 in the forward and backward direction relative to the instrument panel 2B. At this time, in accordance with the movement of the movable bracket 6t, the lower end of the column 1t follows the overall movement of the column 1t through the long hole 3t of the lower bracket 2t and the bolt shaft 4t engaged with this long hole 3t, thereby moving the wheel 9t toward or apart from the vehicle seat 2 side. The movable bracket 6t is moved relative to the fixed bracket 7t in the arrow Y direction in FIG. 2, thereby moving the steering member 10 (column 10 in the upward and downward direction relative to the instrument panel 2B. At this time, in accordance with the movement of the movable bracket 6t, the column 1t tiltingly moves upward or downward around the bolt shaft 4t of the lower bracket 2t.

With reference to FIG. 1, the camera member 20 is a member capable of detecting a state of the vehicle compartment on the vehicle seat 2 side within a curtain measurement range. The camera member 20 of this type may be exemplified by a single-lens camera member or a multiple-lens camera member (stereo camera), and the camera member of either type is capable of detecting the state of the vehicle compartment (e.g., eye point EP) with desired accuracy within a measurement range of the camera member. In the present embodiment, the camera member 20 is installed to the upper portion of the column 1t in a manner as to be movable in the forward and backward direction or in the upward and downward direction with a finder of the camera member 20 facing the vehicle seat 2. This configuration allows the measurement range of the camera member 20 to be movable synchronously with the movement (upward-downward and frontward-backward movement) of the steering member 10 in the same direction as that of the steering member 10.

With reference to FIG. 1, the sliding mechanism SM that is one of the adjusting mechanisms slidingly moves the seat cushion 4 forward and backward in the vehicle compartment, and includes upper rails 2s and lower rails 4s. Each lower rail 4s is a long plate member extending forward and backward along the seat, and has an approximately U shape in its cross sectional view. Each upper rail 2s is a plate member slidably assembled to the corresponding lower rail 4s, and has an approximately inverted U shape in its cross sectional view. In the present embodiment, the seat cushion 4 is installed on a top of each upper rail 2s through the lifter mechanism LM described later, and each lower rail 4s is installed on the floor surface 6B. At this time, each lower rail 4s is installed on a projection 8B on the floor surface 6B via legs 8s disposed at a front portion and a rear portion of the lower rail 4s. The projection 8B is a sloped projection gradually rising from the rear side toward the front side at a tilt angle θ relative to the floor surface 6B. The both rails 2s and 4s are slidably assembled to each other, thereby allowing the seat cushion 4 to slidably move forward and backward relative to the floor surface 6B.

With reference to FIG. 1, the lifter mechanism LM that is one of the adjusting mechanisms moves the entire seat cushion 4 in the upward and downward direction, and includes first link arms 101, and second link arms 201. Each first link arm 101 and each second link arm 201 are plate members, each having an approximately rectangular shape in its side view, and axial parts (reference numerals are omitted in the drawing) are rotatably inserted in both ends of each arm. In the present embodiment, one end of each first link arm 101 is rotatably coupled to a front portion of the seat cushion 4, and the other end of this first link arm 101 is rotatably coupled to a front portion of the upper rail 2s. One end of each second link arm 201 is rotatably coupled to a rear portion of the seat cushion 4, and the other end of this second link arm 201 is rotatably coupled to a rear portion of the upper rail 2s. As the first link arms 101 and the second link arms 201 gradually stand up from a backwardly inclined state by motive power of a motor member (not shown), the seat cushion 4 is gradually lifted upward.

With reference to FIG. 1, the recliner mechanism RM (in a cylindrical shape) that is one of the adjusting mechanisms recliningly moves the seat back 6 relative to the seat cushion 4, and includes an internal mechanism (not shown), and an operational rod 2r. The operational rod 2r is a long pipe member extending in a seat width direction. In the present embodiment, a lower portion of the seat back 6 is turnably assembled to a rear portion of the seat cushion 4 through the recliner mechanism RM. At this time, the operational rod 2r is extendingly disposed at the lower portion of the seat back 6 to be inserted in the internal mechanism in a bridge manner along the seat width direction. The operational rod 2r is rotated by handling an operating lever (not shown) so as to unlock a lock of the internal mechanism. In this manner, the seat back 6 becomes turnable relative to the seat cushion 4 around the operational rod 2r. If the occupant unhands the operating lever, the operational rod 2r reversely rotates due to an urging force of this lever, so that the internal mechanism is put into a locked state, thereby restricting the reclining movement of the seat back 6 relative to the seat cushion 4.

With reference to FIG. 1, in an optimum state of the vehicle seat 2, while the occupant CM moderately leans back against the seat back 6, a leg of the occupant CM is so moderately bent as to reach the pedal 4B. In this state, at least one of the plural mechanisms SM, LM, and RM is so operated as to change the state of the vehicle seat 2 to an optimum state in accordance with the occupant CM in a sitting state. For example, the recliner mechanism RM is so operated as to adjust a reclining degree of the seat back 6 relative to the seat cushion 4, thereby changing the posture of the seat. This operation brings the vehicle seat 2 into a state that allows the occupant CM to moderately lean back against the seat back 6. At least one of the sliding mechanism SM and the lifter mechanism LM is so operated as to adjust a distance between the seat cushion 4 and the pedal 4B in the forward and backward direction and in the upward and downward direction, thereby changing the position of the seat in the vehicle compartment. This operation brings the vehicle seat 2 into a state that allows the leg of the occupant CM to be so moderately bent as to reach the pedal 4B.

In the present embodiment, with reference to a state represented by a two dot chain line in FIG. 1, it is assumed that the occupant CM whose body size is small is seated, and the sliding mechanism SM is operated to bring the seat cushion 4 closer to the pedal 4B. In this case, the display light 31hb (display light indicated by a solid line in FIG. 1) reflected on the wind shield 9B still stays in an initial position even after the state of the vehicle seat 2 is changed. Hence, it is required to appropriately adjust the reflection position of the display light 31hb relative to the wind shield 9B so as to position the eye point EP of the occupant CM at the traveling path of the display light 31hb reflected on the wind shield 9B.

In the present embodiment, with reference to FIG. 1 to FIG. 4, it is configured to automatically and more appropriately position the eye point EP of the occupant CM at the traveling path of the display light 31hb reflected on the wind shield 9B through the following first to third stages. In the first stage, with reference to FIG. 1, and Step 1 and Step 2 in FIG. 4, the position of the eye point EP after the state of the vehicle seat 2 is changed is predicted based on the amount of adjustment of the adjusting mechanism due to change in state of the vehicle seat 2. In a not-shown controller (i.e., ECU), a coordinate (x) in the upward and downward direction and a coordinate (y) in the forward and backward direction of the vehicle compartment are set. With reference to Step 1 in FIG. 4, the state of the vehicle seat 2 and the position of the eye point EP before the movement of the seat are detected by the camera member 20, thereby inputting state information of the vehicle seat 2 (adjusting mechanism) before the movement of the seat as well as coordinate information (coordinates: x0, y0) of the eye point EP before the movement of the seat into the controller in advance. At this time, by moving the camera member 20 along with the steering member 10, the measurement range of the camera member 20 may be appropriately moved toward the eye point EP.

With reference to FIG. 1 and Step 2 in FIG. 4, the amount of adjustment of the sliding mechanism SM (represented as “amount of eye point movement” in FIG. 4) after the operation of the mechanism SM is input into the controller so as to predict the position of the eye point EP of the occupant CM after the state of the seat is changed. In the present embodiment, each lower rail 4s of the sliding mechanism SM is disposed on the projection 8B, thereby allowing the seat cushion 4 to gradually move upward (tilt angle θ) along with its frontward movement through the sliding mechanism SM. At this time, the controller predicts the coordinates (x1, y1) of the eye point EP of the occupant CM in the vehicle seat 2 after the movement of the seat based on the amount of adjustment of the sliding mechanism SM. Based on the tilt angle θ of the lower rails 4s, the coordinate in the forward and backward direction of the eye point EP of the occupant CM after the state of the seat is changed can be obtained by calculation (calculation formula: x1=x0−100 cos θ). Similarly, the coordinate (y1) in the upward and downward direction of the eye point EP of the occupant CM after the state of the seat is changed can also be obtained by calculation (calculation formula: y1=y0+100 sin θ).

In the second stage, with reference to FIG. 1 and Step 3 in FIG. 4, it is determined whether or not the display light 31hb reflected on the wind shield 9B is passing through the predicted position of the eye point EP. At this time, the controller detects an angle of incidence and an angle of reflection of the display light 31hb based on the reflection position of the display light 31hb located at the initial position and the surface shape of the wind shield 9B (such as curvature), thereby recognizing the traveling path of the display light 31hb reflected on the wind shield 9B. If it is determined by the controller that the display light 31hb reflected on the wind shield 9B is passing through the predicted position of the eye point EP, the task is completed without moving the head-up display system HUD (end). To the contrary, if it is determined by the controller that the display light 31hb reflected on the wind shield 9B is not passing through the predicted position of the eye point EP, the task proceeds to the third stage described below.

In the third stage, with reference to FIG. 1 and Step 4 in FIG. 4, the head-up display system HUD is automatically operated so as to move the traveling path of the display light 31hb reflected on the wind shield 9B toward the eye point EP of the occupant CM. At this time, while the angle of incidence and the angle of reflection of the display light 31hb are determined based on the positional information of the display light 31hb reflected from the wind shield 9B, the traveling path of the display light 31hb reflected on the wind shield 9B is moved toward the predicted position of the eye point EP. In the present embodiment, for example, the predicted eye point EP of the occupant CM is positioned more frontward and upward than that before the sliding mechanism SM is operated (see the two dot chain line in FIG. 1). In this state, by appropriately tilting the display device 31h or the free-curved surface mirror 33h, the controller adjusts the reflection position of the display light 31hb in such a manner as to move the traveling path of the display light 31hb reflected on the wind shield 9B upward to the predicted eye point EP. Returning to the second stage, if it is determined that the display light 31hb reflected on the wind shield 9B is passing through the predicted position of the eye point EP, the task is stopped (end). To the contrary, in the second stage, if it is determined that the display light 31hb reflected on the wind shield 9B is not passing through the predicted position of the eye point EP, the third stage is executed again (this means that the second and the third stages are repetitively executed).

In the present embodiment, in the first stage, it is possible to more precisely predict the position of the eye point EP based on the amount of adjustment of the adjusting mechanism. Accordingly, in the second stage, it is possible to more appropriately determine whether or not the display light 31hb reflected on the wind shield 9B is passing through the predicted position of the eye point EP (eye point after the state of the seat is changed). In the third stage, it is possible to automatically operate the head-up display system HUD, thereby positioning the eye point EP of the occupant CM at the traveling path of the display light 31hb reflected on the wind shield 9B. Hence, according to the present embodiment, it is possible to automatically and more appropriately position the eye point EP of the occupant CM at the traveling path of the display light 31hb reflected on the wind shield 9B.

In the third stage, alternatively, the eye point EP of the occupant CM may be positioned at the traveling path of the display light 31hb reflected on the wind shield 9B by automatically operating the adjusting mechanism. In a variation of the present embodiment, for example, with reference to FIG. 1, it is assumed that the display light 31hb reflected on the wind shield 9B is located more downward than the predicted position of the eye point EP of the occupant CM (see the solid line in FIG. 1). In this state, the sliding mechanism SM or the lifter mechanism LM is so operated as to move the seat cushion 4 downward, thereby moving the eye point EP of the occupant CM downward to the display light 31hb reflected on the wind shield 9B. In this manner, by automatically operating the adjusting mechanism, it is also possible to automatically and more appropriately position the eye point EP of the occupant CM at the traveling path of the display light 31hb reflected on the wind shield 9B.

The vehicle seat of the present embodiment is not limited to the aforementioned embodiments, and other various embodiments may also be applicable thereto. In the embodiments of the present invention, an example of operating the sliding mechanism SM has been described, but the other mechanisms (the lifter mechanism LM, the recliner mechanism RM) may also be operated. For example, in the case of operating the lifter mechanism, it is possible to find the eye point of the occupant after the operation of this mechanism through calculation based on the tilt angle of each link arm, and the like. In the case of operating the recliner mechanism, it is possible to find the eye point of the occupant after the operation of this mechanism through calculation based on the reclining angle of the seat back relative to the seat cushion, and the like.

In the present embodiment, the configuration of the head-up display system HUD has been exemplified, but this is not intended to limit the configuration (shape, dimension, installing position, etc.) of this system. Instead of using the camera member, other sensors may be used for detecting coordinate information regarding the vehicle seat (adjusting mechanisms) before the movement of the seat, or detecting coordinate information regarding the eye point before the movement of the seat. As another sensor of this type, a non-contact type (ultrasonic type, laser type, eddy-current type) sensor may also be disposed at an appropriate position in the vehicle compartment.

The configuration of the vehicle seat 2 (adjusting mechanisms SM, LM, RM), the configuration of the steering member 10, and the basic components of the vehicle compartment 2B, 4B, 6B according to the embodiments of the present invention may be appropriately modified. The configurations of the embodiments may be applicable to comprehensive transportation means, such as vehicles, aircrafts, and trains, etc.

What is claimed is:

1. A control method for a vehicle, the vehicle including a head-up display system, a vehicle seat, and a wind shield that reflects a display light of the head-up display system toward the vehicle seat, wherein the vehicle seat includes an adjusting mechanism that changes a state of the vehicle seat in accordance with an occupant in a sitting state by changing a posture of the vehicle seat, or a position of the vehicle seat in a compartment of the vehicle, the head-up display system adjusts a reflection position of the display light relative to the wind shield so as to move a traveling path of the display light reflected on the wind shield in an upward and downward direction, and the control method for the vehicle operates the adjusting mechanism in a manner as to change the state of the vehicle seat in accordance with the occupant in the sitting state, and to position an eye point of the occupant at the traveling path of the display light reflected on the wind shield,
the control method for the vehicle comprising:
predicting a position of the eye point of the occupant after the state of the vehicle seat is changed, based on amount of adjustment of the adjusting mechanism due to change in state of the vehicle seat;
determining whether or not the display light reflected on the wind shield is passing through the predicted position of the eye point; and
if it is determined that the display light reflected on the wind shield is not passing through the predicted position of the eye point, automatically operating the head-up display system or the adjusting mechanism so as to move one of the traveling path of the display light reflected on the wind shield and the eye point of the occupant toward the other.
